(19) United States
(12) Patent Application Publication
(10) Pub. No.: US 2006/0053190 A1
(43) Pub. Date: Mar. 9, 2006

(54) Construction of a folded leading zero anticipator

(75) Inventors: Sang Hoo Dhong, Austin, TX (US); Christian Jacobi, Boblingen (DE); Hwa-Joon Oh, Austin, TX (US); Silvia Melitta Mueller, Altdorf (DE); Yonetaro Totsuka, Austin, TX (US)

Correspondence Address: IBM CORPORATION (CS);C/O CARR LLP, 670 FOUNDERS SQUARE, 900 JACKSON STREET, DALLAS, TX, 75202, US

(73) Assignees: International Business Machines Corporation, Armonk, NY (US); Sony Computer Entertainment Inc., Tokyo (JP)

(21) Appl. No.: 10/937,693

(22) Filed: Sep. 9, 2004

(51) Int. Cl. G06F 7/38

(52) U.S. Cl. 708/495

(57) ABSTRACT

An apparatus, a method, and a computer program are provided for anticipating leading zeros for a Floating Point (FP) computation. Traditional leading zero anticipators (LZA) are typically very wide. To reduce the width of the LZA, it is subdivided to two smaller LZA that compute edge vectors for the most and least significant bits of intermediate resultant vectors. Therefore, a LZA can be easily folded to reduce the area requirement so as to increase the versatility of the LZA.

### FIELD OF THE INVENTION

The present invention relates generally to computational logic, and more particularly, to floating point units (FPU).

### DESCRIPTION OF THE RELATED ART

In conventional FPUs, leading zero-anticipators (LZAs) are commonly used. LZAs are primarily utilized to anticipate the number of leading zeros of an FPU intermediate result. The result from the LZA can then allow a normalization shifter to shift out all of the zeros in an intermediate result. Oftentimes, though, the LZA is a time critical element. Moreover, LZAs often have to be folded because some conventional floorplans are not wide enough to accommodate a full LZA. For example, in double precision FPUs, the LZA has a width of approximately 108 bits, but the LZA has to be folded into two rows of 54 to fit.

Referring to FIG. 1 of the drawings, the reference numeral 100 generally designates a conventional anticipation and normalization logic. The logic 100 comprises an LZA 102 and a normalization shifter 108. The LZA 102 further comprises an edge vector module 104 and a leading zero counter 106.

In order to function, two intermediate results of a Floating Point (FP) operation are operated on. Two intermediate results, A and B (not shown), are input into the edge vector module 104 through a first communication channel 110 and a second communication channel 112, respectively. The edge vector module 106 then computes an edge vector, which reflects the location of the leading 1 in the sum S (not shown) of the two intermediate results, A and B (not shown). The edge vector, however, may have an error associated with it; there may be error in calculating the leading zeros, but the error is no greater than 1. As an example, the following equations illustrate edge vector computations:

| | |
|---|---|
| A = 00001000 | A′ = 00000001 |
| B = 00000000 | B′ = 00000111 |
| A + B = 00001000 | A′ + B′ = 00001000 |
| E = 00001xxx | E′ = 000001xx |

where A, B, A′, and B′ are input vectors and E and E′ are the edge vectors. As shown, the sum of vectors A and B equal the sum of the vectors A′ and B′. However, the edge vectors E and E′ are different. Both edge vectors anticipate the number of leading zeros but can be off by one position to the right as seen with the edge vector E′. Therefore, an edge vector is only fully defined for a given set of intermediate results, such as vectors A and B.

Once the edge vector has been computed, then the edge vector is provided to the leading zero counter 106 through a third communication channel 114. The leading zero counter 106 then precisely counts the number of leading zeros of the edge vector, and hence, anticipates the number of leading zeros of the sum with the possible error in the edge vector. The leading zero counter 106 typically has two outputs: a zero output (not shown) and a number output. The zero output (not shown) outputs a value of 1 if all of the bits from the edge vector module 104 are 0. However, if there are not all zeros in the edge vector, then the number of leading zeros are communicated to the normalization shifter 108 through a fourth communication channel 116. Additionally, the normalization shifter 108 receives a sum amount from an adder (not shown) through a fifth communication channel 118. The number of leading zeros is transmitted in binary format such that the normalization shifter 108 can perform the required shift. Also, the normalization shifter 108 contains a plurality of internal muxes (not shown) that perform the normalization.

A consideration, though, is that the LZA is oftentimes a time critical element. But, because most floorplans are not wide enough to support a full-width LZA, time required to anticipate the number of leading zeros can be increased. Therefore, there is a need for a method and/or apparatus for a LZA that at least addresses some of the problems associated with conventional LZAs when the floorplan width is not sufficient.

### SUMMARY OF THE INVENTION

The present invention provides an apparatus for computing the number of leading zeros of an intermediate result in a Floating Point (FP) operation. In the apparatus, there is a leading zero anticipator and a multiplexer (mux). The leading zero anticipator independently anticipates leading zeros for the most and the least significant bits of two intermediate results of the FP operation. Based on the output of the leading zero anticipator, the mux is able to pre-normalize the FP operation.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a conventional anticipation and normalization logic;

FIG. 2 is a block diagram depicting division of the input and sum vectors;

FIG. 3 is a block diagram depicting modified anticipation and normalization logic; and

FIG. 4 is a flow chart depicting the operation of modified anticipation and normalization logic.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

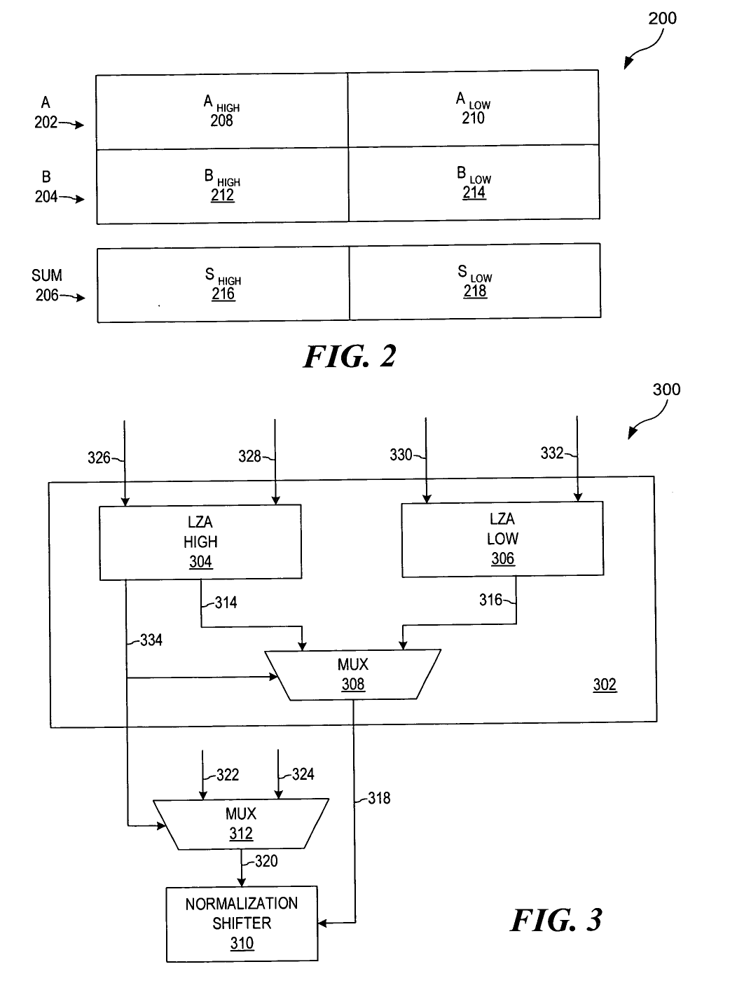

Referring to FIG. 2 of the drawings, the reference numeral 200 generally designates a division of the input and sum vectors. The vectors 200 comprise an input vector A 202, an input vector B 204, and a sum vector 206. The input vector A 202 comprises an A_{high} vector 208, which comprises the most significant bits of the input vector A 202, and an A_{low} vector 210, which comprises the least significant bits of the input vector A 202. However, the last bits of the A_{high} vector 208 and the first bits of the A_{low} vector 210 do overlap by two positions because the edge vector uses two bits to “look back.” The input vector B 204 comprises a B_{high} vector 212, which comprises the most significant bits of the input vector B 204, and a B_{low} vector 214, which comprises the least significant bits of the input vector B 204. However, the last bits of the B_{high} vector 212 and the first bits of the B_{low} vector 214 do overlap. The sum vector 206 further comprises a S_{high} vector 216, which comprises the most significant bits of the sum vector 206, and a S_{low} vector 218, which comprises the least significant bits of the sum vector 206.

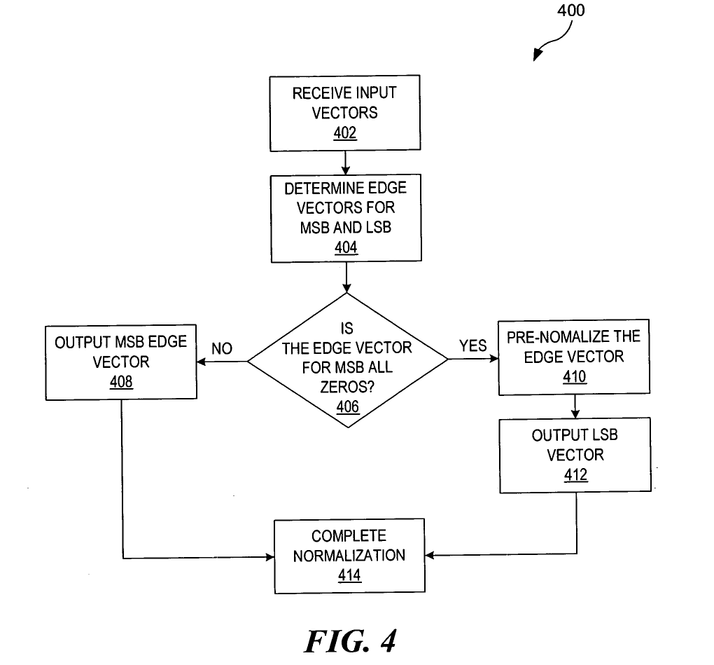

The use of the vectors 200 is specifically for a divided LZA. Having a divided LZA would allow for simultaneity or near simultaneity of computation for the high and low parts of the input vectors. Moreover, the overall floorplan width of an LZA can be reduced because the two parts can be stacked vertically without long horizontal wires that would affect timing. Referring to FIGS. 3 and 4 of the drawings, the reference numerals 300 and 400 generally designate modified anticipation and normalization logic and the operation of the modified anticipation and normalization logic, respectively. The logic 300 comprises a modified LZA 302, a normalization shifter 310, and a first multiplexer (mux) 312. The modified LZA 302 comprises an LZA high 304, an LZA low 306, and a second mux 308.

The modified logic 300 functions by receiving each of the respective input vectors. In step 402, the LZA high 304 receives A_{high} 208 and B_{high} 212 through a first communication channel 326 and a second communication channel 328, respectively. The LZA low 306 receives A_{low} 210 and B_{low} 214 through a third communication channel 330 and a fourth communication channel 332, respectively. In step 404, each of the LZA high 304 and LZA low 306 determines a high-part edge bit vector (not shown) for the MSBs of the input vectors and a low-part edge bit vector (not shown) for the LSBs of the input vectors, respectively, that indicate the number of leading 0's of the respective part of the sum. Also, the first mux 312 receives high and low sum outputs from an adder (not shown) through a fifth communication channel 322 and a sixth communication channel 324, respectively.

With the differentiation of LZA into two components, two cases develop as to the interpretation of the zero outputs of LZA high 304. A determination is made as to whether there are any 1's in the high-part edge vector (not shown) in step 406. The zero output of the LZA high 304 is transmitted to the first mux 312 and the second mux 308 through a seventh communication channel 334 as a select signal for both muxes 308 and 312. If the zero output of LZA high 304 is 1, the high-part bit edge vector (not shown) contains only 0's. Under these circumstances, the entire high part would be shifted away by the first mux 312. Therefore, in step 410, the first mux 312 would pre-normalize the sum and shift out the leading zeros from the high-part sum bit vector and transmit the data from remaining low-part bit vector from the sixth communication channel 324 to the data port (not shown) of the normalization shifter 310 through a ninth communication channel 320. Also, the second mux 308 would be instructed to select the count-leading-zero output from the LZA low 306 and transmit the shift amount to the shift amount port (not shown) of the normalization shifter 310 through an eighth communication channel 318.

However, if the zero output of the LZA high 304 is 0, then the high-part sum bit vector (not shown) contains at least one 1. The determination, though, of the whether the high-part sum bit vector (not shown) contains any 1's is an anticipated result. Therefore, the number of leading zeros in the whole sum would be equal to the number of leading zeros in the S_{high} 216, which is anticipated by LZA high 304. Also, the second mux 308 would be instructed to select the count-leading-zero output from the LZA high 304. The high-part bit sum vector (not shown) containing the number of leading zeros could then be transmitted to the first mux 312 through the fifth communication channel 322 and transmit the data from the high part bit vector from the fifth communication channel 322 to the data port (not shown) of the normalization shifter 310 through the ninth communication channel 320. Also, the second mux 308 would be instructed to select the count-leading-zero output from the LZA high 304 and transmit the shift amount to the shift amount port (not shown) of the normalization shifter 310 through the eighth communication channel 318.

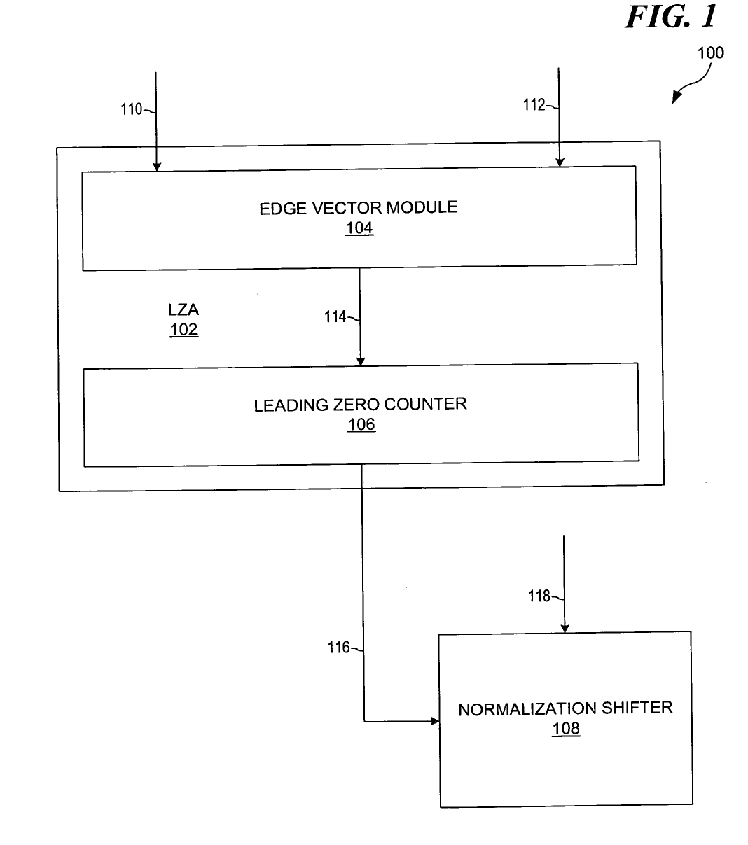

However, in order for normalization to continue, then the amounts from the respective muxes 308 and 312 are transmitted to the normalization shifter 310. In step 408, if there is at least one 1 in the high-part bit vector, then the number of leading zeros are transmitted to the normalization shifter 310 through the eighth communication channel 318 and the un-normalized sum is transmitted to the normalization shifter 310 through the ninth communication channel 320. In step 412, if the high-part bit vector is all 0's, then the number of leading zeros for the low-part bit vector is transmitted to the normalization shifter 310 through the eighth communication channel 318, and the pre-normalized sum is transmitted to the normalization shifter 310 through the ninth communication channel 320. The normalization shifter 310 can then finalize the normalization in step 414 for both cases It should be noted that the normalization shifter 310 is smaller than the normalization shifter 108 of FIG. 1 because the first normalization has already taken place in the first mux 312. The width of the inputs to the shifter 108 in FIG. 1 is the width of the whole sum, while in FIG. 3 it is only the width of the S_{high} and S_{low} whichever is wider.

Because the LZA 302 may be incorrect, additional measures to insure accuracy are employed. In the design of the LZA 302, it is possible that the position of the leading zero may be shifted one position too far. The input to the normalization shifter 310 is, thus, padded with the LSB of the S_{high} in an advanced position, if there is a determination that there are not any 1's in the high-part bit edge vector. Otherwise, the input is padded with 0. When examining the entire edge vector, the LSB of the high-part bit vector (not shown) may be overlooked by the LZA high 304, leading to an error or misanticipation. Therefore, providing the padding will prevent an error that results from the loss of a ‘1’ from the LSB of the high-part bit vector if there is a misanticipation.

Moreover, the utilization of the first mux 312 differs from more conventional approaches that enable an LZA, such as the LZA 302, to be more versatile. In conventional shifters, there can be a first stage shifting that performs shifts with distance multiple of power-of-2. The limitation to multiples of powers-of-2 is needed because of the complexity associated with other decoding methods of binary shift amounts to non-power-of-2 distances. The first mux 312 is controlled by the zero output of the LZA high 304, which can perform a shift by an arbitrary distance. Hence, there is not a limit to a power-of-2, enabling the first shift step performed by the pre-shift to shift by an arbitrary amount. For example, if an LZA is 108 bits wide, then two smaller 54 bit LZA can be used instead. The disassociation then allows for increased versatility in creating a floorplan. Also, because the computation of the zero output of the LZA high 304 is faster than the count-leading-zero outputs of the LZAs, shifting can begin while the count-leading-zero outputs of the LZAs are being computed, which can eliminate a delay of two to three logic stages. Additionally, the normalization performed by the normalization shifter 310 can follow any scheme, but binary shifting is the most common scheme.

There are also a variety of other implementations of splitting and counting leading zeros for a FP operation. The idea can be utilized for leading sign anticipation, which anticipates the number of leading sign bits of a 2's complement number. Also, other schemes can be employed that may have an error in determining the edge vector of one position to the left for which the modified logic can also be applied. Additionally, a Count Leading Zero circuit (CLZ) can be employed in series with an adder to precisely determine the leading zeros from a precise sum, which would also allow for vertically stacked logic with a reduced width.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. An apparatus for counting leading zeros in a Floating Point (FP) operation, comprising:
an anticipator that divides at least one intermediate result of the FP operation into a plurality of bit sets and independently anticipates leading zeros for a sum of the at least one intermediate result per set of the FP operation; and
at least one multiplexer (mux) that is at least configured to receive an output from the leading zero anticipator to allow for pre-normalize the FP operation.

2. The apparatus of claim 1, wherein the FP operation is addition.

3. The apparatus of claim 1, wherein the FP operation is fused multiply-add.

4. The apparatus of claim 1, wherein the anticipator is a leading zero anticipator (LZA) or a leading sign anticipator.

5. The apparatus of claim 1, wherein the anticipator is a Count Leading Zero circuit (CLZ).

6. The apparatus of claim 1, wherein the leading zero anticipator further comprises:
a high anticipator for anticipating the leading zeros for the set of most significant bits of the at least two intermediate results of the FP operation and for outputting a zero high signal; and
a low anticipator for anticipating the leading zeros for the set of least significant bits of the at least two intermediate results of the FP operation.

7. The apparatus of claim 6, wherein the at least one mux is at least configured to pre-normalize an FP operation intermediate result based on the zero high signal.

8. The apparatus of claim 1, wherein the leading zero anticipator further comprises:
a plurality of modules for independently anticipating leading zeros for the set of most significant bits of at least two intermediate results of the FP operation and for the set of least significant bits of the at least two intermediate results of the FP operation;
at least one module of the plurality of modules is at least configured to output a zero high signal; and
at least one intermediate mux that is at least configured to receive outputs of each of the plurality of modules.

9. The apparatus of claim 8, wherein the at least one mux is at least configured to pre-normalize the FP operation based on the zero high signal.

10. A method for counting leading zeros in a FP operation, comprising:
computing a first edge vector from a set of most significant bits of at least one intermediate results of the FP operation from a first module;
computing a second edge vector from a set of least significant bits of the at least one intermediate results of the FP operation into a second module; and
pre-normalizing the FP operation if the first edge vector comprises all zeros.

11. The method of claim 10, wherein the method further comprises normalizing the FP operation based on the first edge vector if the first edge vector does not comprise all zeros.

12. The method of claim 10, wherein the step of pre-normalizing further comprises:
receiving a high zero signal from the first module by at least one mux if the first edge vector comprises all zeros; and
shifting away each position of the FP operation that corresponds to a position of the first edge vector.

13. The method of claim 10, wherein the method further comprises normalizing by shifting away remaining zeros based on the second edge vector.

14. The method of claim 10, wherein the step of pre-normalizing further comprises accounting for errors resulting from a misanticipation of a leading 1 of the FP operation.

15. A computer program product for counting leading zeros in a FP operation, the computer program product having a medium with a computer program embodied thereon, the computer program comprising:
computer code for computing a first edge vector from a set of most significant bits of at least one intermediate results of the FP operation from a first module;
computer code for computing a second edge vector from a set of least significant bits of the at least one intermediate results of the FP operation into a second module; and
computer code for pre-normalizing the FP operation if the first edge vector comprises all zeros.

16. The computer program product of claim 14, wherein the computer program product further comprises computer code for normalizing the FP operation based on the first edge vector if the first edge vector does not comprise all zeros.

17. The computer program product of claim 15, wherein the computer code for pre-normalizing further comprises:
computer code for receiving a high zero signal from the first module by at least one mux if the first edge vector comprises all zeros; and
computer code for shifting away each position of the FP operation that corresponds to a position of the first edge vector.

18. The computer program product of claim 15, wherein the computer program product further comprises computer code for normalizing by shifting away remaining zeros based on the second edge vector.

19. The computer program product of claim 15, wherein the computer code for pre-normalizing further comprises computer code for accounting for errors resulting from a misanticipation of a leading 1 of the FP operation.
